(19) United States
(12) Patent Application Publication
(10) Pub. No.: US 2023/0279716 A1
(43) Pub. Date: Sep. 7, 2023

(54) Federbelasteter Rastbolzen

(71) Applicant: U-Shin Deutschland Zugangssysteme GmbH, Erdweg (DE)

(72) Inventors: Franz Kummer, Augsburg (DE); Nicolas Lejeune, Landshut (DE)

(21) Appl. No.: 18/172,491

(22) Filed: Feb. 22, 2023

(30) Foreign Application Priority Data
Feb. 22, 2022 (DE) 10 2022 104 079.8

(51) Int. Cl. E05F 15/622

(52) U.S. Cl. CPC E05F 15/622; E05Y 2900/532; E05Y 2900/546; E05Y 2900/536

(57) ABSTRACT

Spindle assembly for a spindle drive device (10) comprising a thrust tube (30) and a spindle nut (32), which is arranged on the thrust tube (30) in a rotationally fixed manner, wherein the spindle nut (32) can be brought into threaded engagement with a spindle (26) of the spindle drive device (10), and wherein an end stop for the spindle nut (32) is arranged on the spindle (26), wherein the end stop comprises a damping element (36) consisting of a resiliently formed and hollow-cylindrically shaped stamped part (60).

The invention relates to a spindle assembly for a spindle drive device according to the generic concept of claim 1.

To open and close doors, tailgates or hoods of a motor vehicle automatically and in a controlled manner, electric drives are used in combination with passive components such as, for example, gas pressure springs.

The electric drives often comprise spindle drive devices, which usually comprise an electric spindle drive by means of which the associated vehicle tailgate can be opened and/or closed.

A user of an associated vehicle therefore no longer needs to perform the opening and closing manually. They only need to send a command to open or close to the spindle drive assembly, which they can do, for example, via a radio remote control or via a switch located in the vehicle.

To enable a change in length of the spindle drive device, a spindle driven by a motor gear unit is rotated, which spindle engages in a spindle nut. The spindle nut itself is fixed in translation and rotation by a thrust tube.

To prevent the spindle nut from moving beyond the free end of the spindle, an end stop is usually provided at the free end of the spindle, which also serves as a guide element for the spindle in the thrust tube.

DE 10 2017 127 859 A1 shows a spindle drive device for a closure element of a motor vehicle, wherein an end stop in the form of a damping device is provided at the end of the spindle.

The damping device protects the motor gear unit used to drive the spindle from excessive loads. The damping element is configured as a sleeve-shaped plastic part that deforms plastically when a force is applied.

An end stop with a similar damping element is known from WO 2015 032 554 A1.

The known damping elements are plastically deformed upon impact with the spindle nut such that the impact energy is largely absorbed.

This impact situation does not, however, generally occur during normal operation of the drive device, but rather only in the cases of a misuse situation, during installation in the motor vehicle or a defect, wherein a plastic deformation of the damping element cannot for the most part be reversed, and the damping element should be replaced in the event of damage.

The configuration of the damping element arranged on the spindle is, in particular, a subject matter of the invention.

It is the task of the invention to improve the end stop of the spindle in a spindle assembly for a spindle drive device.

The task is solved by a spindle assembly and an end stop associated with the spindle assembly and having the features of claim 1.

Preferred configurations of the invention and further advantageous features are given in the subclaims.

The described spindle assembly for a spindle drive device comprises a thrust tube and a spindle nut, which is arranged on the thrust tube in a rotationally fixed manner, wherein the spindle nut can be brought into threaded engagement with a spindle of the spindle drive device and wherein an end stop for the spindle nut is arranged on the spindle.

According to the invention, the end stop comprises a damping element consisting of a stamped part which is hollow-cylindrical in shape and has spring-elastic properties. The end stop is preferably made from a stamped spring steel sheet and has the function of an elastic spring steel sleeve. The damping element can therefore also be referred to as a tubular spring.

In contrast to the damping elements known from the prior art, elastic deformation of the damping element occurs when a load is applied, such that the damping element does not undergo plastic deformation and is thus damaged or destroyed, but rather returns to its original shape on its own.

This stamped part is simple and inexpensive to manufacture and easy to install.

This results in a spring-elastic stamped end stop for the spindle drive, which has significant advantages over previously known damping elements with plastic deformation.

In a preferred configuration of the invention, the damping element is loosely arranged on the spindle at a defined position by means of a clearance fit, which is to say, it can be axially displaced on the spindle under load. With respect to its axial longitudinal extension in the vertical direction, the damping element or alternatively stamped part has a number of elongated—preferably horizontal-cutouts extending in the circumferential direction, which are arranged in a number of rows running in the circumferential direction of the stamped part and offset from one another. A series of solid state springs are hereby formed. Between the cutouts laid out in an offset manner, there are webs which transfer the force from one solid state spring to the other under load. The sum of these individually configured solid state springs gives the damping element its spring-elastic properties.

The multiple rows of cutouts in the cylindrically curved stamped part produce a spring-elastic element of the type of a spring sleeve or tubular spring, which exhibits springy properties similar to multiple disc springs stacked on one another or to bending springs having the same effect.

The cutouts of the stamped part preferably have a stress-optimized dumbbell-shaped or bone-shaped configuration.

Such a bone-shaped cutout preferably consists of two horizontally opposed semicircular arches punched out at intervals in the sheet material, the boundary sides of which are connected by a punched-out center area. The center area is indented in the shape of a bone because its opposing edge sides have a smaller distance between one another than the radius of the semicircular arches at the ends. This results in the characteristic bone shape of the cutouts. When a vertically directed force vector acts on the spring structure of the damping element, the sheet metal structures forming the center area of the cutouts each act as a bending spring inasmuch as the center area of the cutout undergoes elastic deformation.

The bone-shaped configuration of the cutouts punched out of the spring steel sheet has the advantage that a large plurality of bending springs distributed horizontally around the circumference are formed in the slotted spring sleeve and stacked on top of one another in a vertical direction. This results in a symmetrical bending structure without the risk of canting of the damping element and asymmetrical loading.

For further protection against canting, it may be provided in a second embodiment of the invention that the sleeve-shaped, slotted damping element respectively has a curled rim at its end faces which increases the diameter. The curled rim is formed from the material of the spring steel sheet and is beveled at an angle of about 90 degrees to the longitudinal center axis of the damping element. This eliminates the need for an enlarged-diameter washer adjacent to the end faces of the damping element, which is provided in the first embodiment for symmetrical force application to the slotted sleeve body.

Both embodiments provide that the longitudinal sides of the spring steel sheet joining to form a sleeve form a gap extending in the vertical direction. In this embodiment, the longitudinal sides can only touch, but are not connected to each other.

In a second configuration of such a vertical gap, it may be provided to provide vertically spaced spot-welded joints between the opposing longitudinal sides of the spring steel sheet.

In a third configuration, it may be provided to span the longitudinally extending gap between the two opposite ends of the spring steel sheet. In this case, the damping element is configured as a winding body and preferably comprises at least two mutually overlapping windings, namely an inner winding and an outer winding that covers the inner winding. The winding structure is preferably configured in such a way that the inner longitudinal side of the inner winding is opposite the outer longitudinal side of the outer winding, so that when a vertical force is applied to the sleeve-shaped spring body, the result is a uniform deformation of all the bending springs formed by the edge sides of the cutouts.

Finally, in a fourth configuration, with regard to the formation of the vertical gap, it can be provided that a plurality of tab connections spanning the gap can be provided between the opposing vertical longitudinal sides of the sheet metal strip.

With regard to the configuration of the vertical longitudinal gap, the four embodiments described above can be combined in any desired set-up, either individually or as a plurality combined with one another.

The end is closed by a thrust washer at the end of the damping element facing the spindle motor, which thrust washer is also movably arranged on the spindle and against which the spindle nut may optionally abut.

At the other end of the damping element there is a bearing element, which rests on the inner circumference of the thrust tube.

The entire end stop assembly comprises the thrust washer, the damping element and the bearing element and is fixed to the spindle by a securing disk.

The spindle assembly according to the invention is part of a spindle drive device, such as may be used to move doors, tailgates or hoods of a motor vehicle.

A plurality of embodiment examples of the invention are elucidated in more detail below with reference to the drawings. In this connection, further features and advantages of the invention will become apparent.

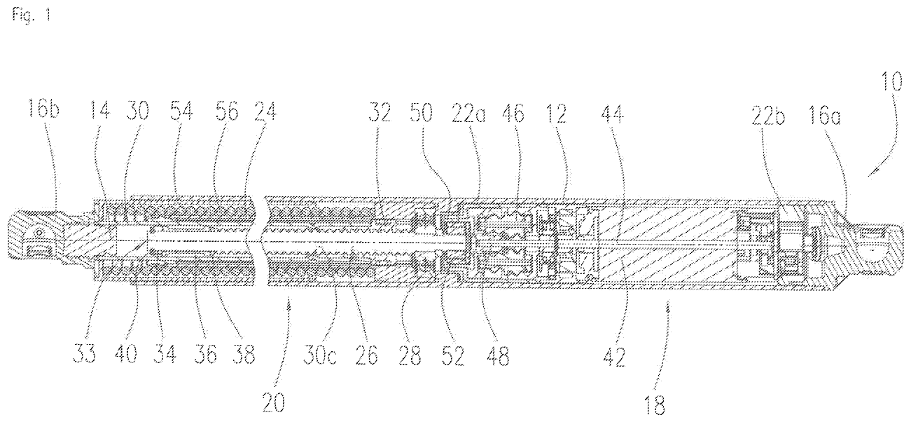

FIG. 1 shows a cross-section through a spindle drive device in which the spindle assembly according to the invention is used.

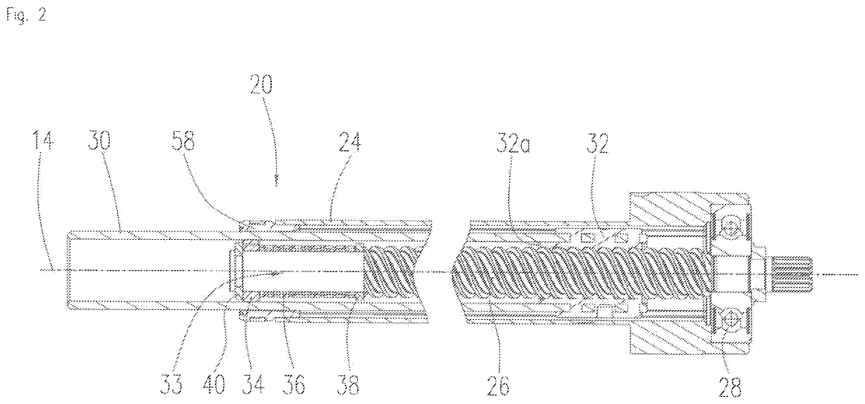

FIG. 2 shows an enlarged cross-section through the spindle unit.

FIG. 3 shows a view of the end stop on the spindle.

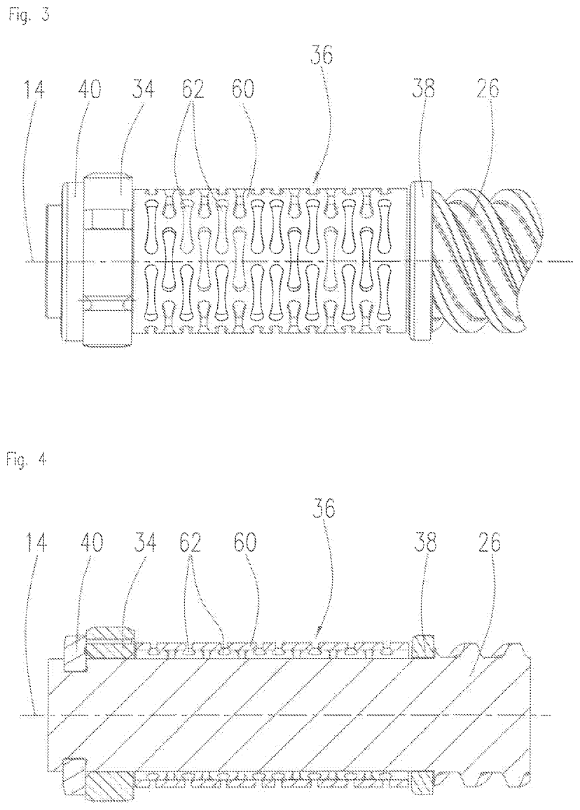

FIG. 4 shows a longitudinal cross-section through the end stop and the spindle.

FIG. 5 shows a stamped part for the production of a damping element.

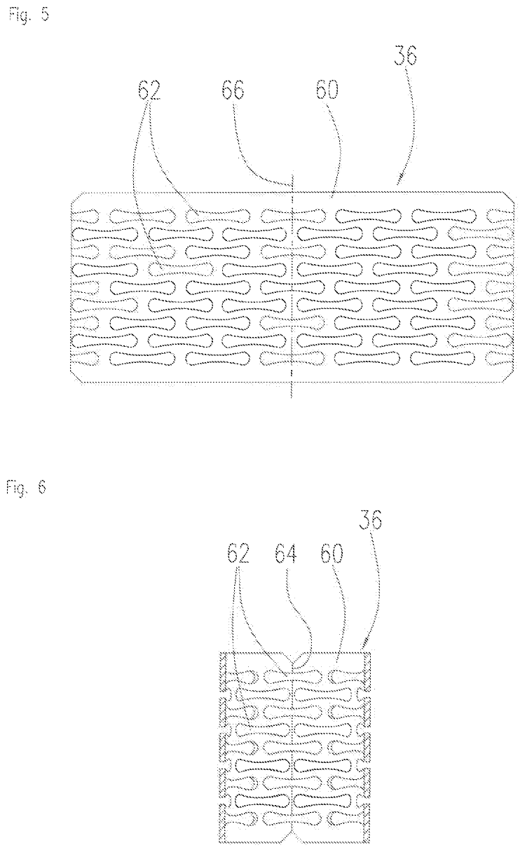

FIG. 6 shows a side view of the damping element consisting of the cylindrically rolled stamped part.

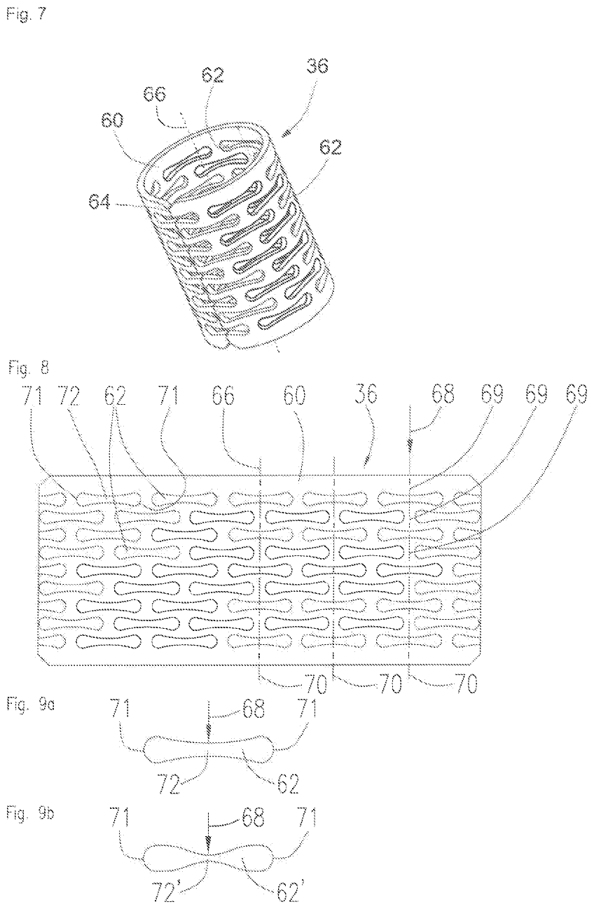

FIG. 7 shows a perspective view of the damping element consisting of the cylindrically rolled stamped part.

FIG. 8 shows an illustration similar to FIG. 5 with elucidation of the spring function.

FIG. 9a and FIG. 9b show the function of the bending springs formed by the cutout in the spring plate.

FIG. 10 shows a modified second embodiment of a damping element with curled rims on the end face.

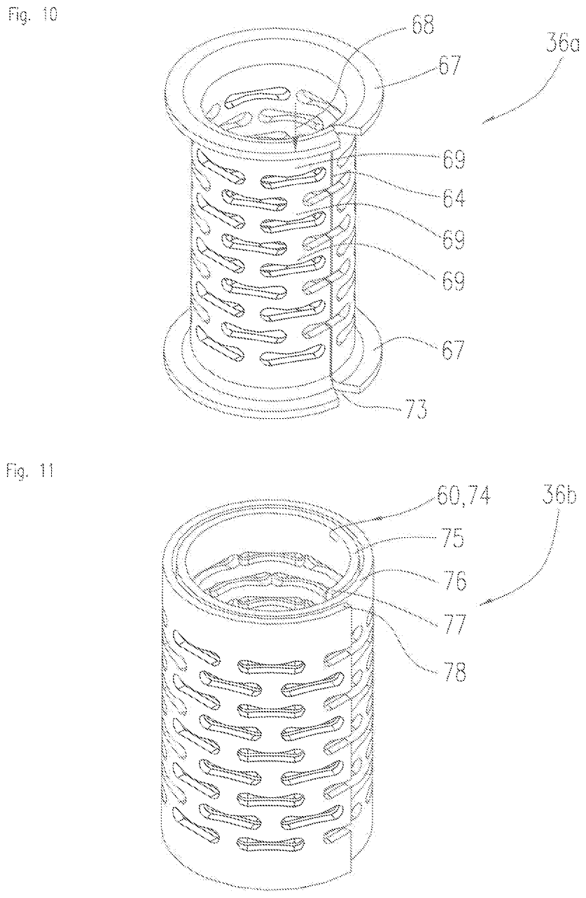

FIG. 11 shows a modified third embodiment of a damping element as a hollow cylindrical winding body made of a strip of spring sheet metal

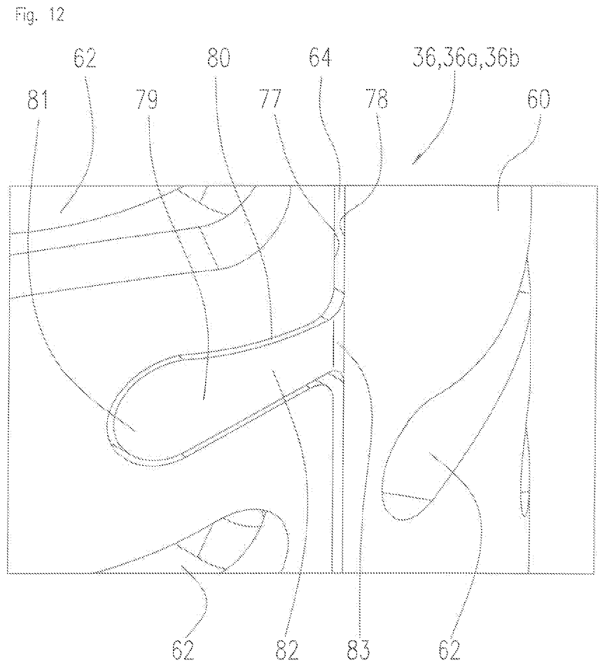

FIG. 12 shows an enlarged detail view of a tab connection spanning the vertical gap.

FIG. 1 shows a spindle drive device 10, preferably for motorized opening and closing of a vehicle tailgate (not shown).

The spindle drive device 10 comprises a spindle housing 12, which extends along a spindle axis 14, and a first end piece 16a, which is, for example, attached to the vehicle body, and a second end piece 16b, which is connected to the vehicle tailgate to be actuated.

A motor gear unit 18 and a spindle unit 26 are arranged in the spindle housing 12.

In the embodiment shown, the motor gear unit 18 is mounted non-rotatably in the spindle housing 12 by means of two bearing elements 22a, 22b.

The spindle unit 20 comprises a guide tube 24 in which a spindle 26 is mounted. At its end facing the motor gear unit 18, the spindle 26 is preferably rotatably mounted in the guide tube 24 by means of a roller bearing 28.

In the embodiment shown, the guide tube 24 is fastened to the spindle housing 12, for example, glued or welded to the spindle housing.

A thrust tube 30 is arranged between the guide tube 24 and the spindle 26, which thrust tube is coupled to the spindle 26 by means of a spindle nut 32 which is arranged axially and rotationally fixed in the thrust tube 30.

The free end of the spindle 26 is rotatably mounted and axially guided in the thrust tube 30 by means of a bearing assembly 33. The bearing assembly 33 further serves as an end stop for the spindle nut 32, with which an axial movement of the spindle nut 32 on the spindle 26 is limited so that the spindle nut 32 cannot move beyond the free end of the spindle 26.

The bearing assembly 33 preferably comprises a bearing element 34 and an elastically deformable damping element 36, which is arranged between a thrust washer 38 facing the spindle nut 32 and a securing disk 40 and are arranged on the spindle 26.

The motor gear unit 18 comprises a drive motor 42 with a motor shaft 44, which drives a gear shaft 48 via a Oldham-type coupling, a ring gear 50 is provided on the output via an epicyclic gearing 46, which is rotationally coupled to the spindle 26 via a coupling 52. The ring gear 50 is rotatably mounted in the spindle housing 12 or in a gear housing not described in more detail. The spindle nut 32 is fastened to one end of the thrust tube 30. The spindle nut 32 is preferably made of plastic and is connected to the metal thrust tube 30 in an axially and rotationally fixed manner.

The other end of the thrust tube 30 is connected to a housing tube 54 by means of an end piece 16h.

When the spindle 26 is rotated by the motor gear unit 18, the spindle nut 32 and the thrust tube 30 connected thereto perform a translational movement along the spindle 26. In so doing, the thrust tube 30 and the associated housing tube 54 move telescopically relative to the spindle housing 12 to move the vehicle tailgate from a first position to a second position.

A compression spring 56 is arranged within the housing tube 54 in order to power assist the spindle drive 20 in extending the housing tube 54.

The compression spring 56 surrounds the guide tube 24 and is supported at one end on a stop on the guide tube 24 and at the other end on the housing tube 54.

FIG. 2 shows an enlarged cross-section through the spindle unit, in particular in the area of each end of the spindle 26.

At its rear end, the spindle 26 is rotatably mounted in the guide tube 24 by means of a roller bearing 28 and is driven in rotation by the motor gear unit 18 (FIG. 1).

The spindle nut 32 engages in the thread of the spindle 26 and is firmly connected to the thrust tube 30.

When the spindle 26 rotates, the spindle nut 32 moves linearly, guided by the guide tube 24 along the spindle axis 14, such that the thrust tube 30 also moves linearly relative to the guide tube 24.

A guide sleeve 58 is arranged at the front end of the guide tube 24 to guide the thrust tube 30. Moreover, the guide sleeve 58 seals the thrust tube 30 against environmental influences or contamination.

An end stop with a damping element 6 is provided at the front free end of the spindle 26.

The end stop is fixed firmly to the spindle 26 by means of the securing disk 40.

A bearing element 34 rests against the securing disk 40, which bearing element slides against the inner circumferential surface of the thrust tube 30. Upon rotation of the spindle 26 and the resulting translational movement of the thrust tube 30, the thrust tube 30 slides along the bearing member 34.

The damping element 36 is in contact with the bearing element 34, which damping element is limited at the other end by a thrust washer 38.

The damping element 36 and the thrust washer 38 are arranged loosely on the spindle 26 and are fixed on the left side of the drawing only by the bearing element 34 and the securing disk 40 which is fastened to the end of the spindle 26.

When the spindle 26 rotates, the spindle nut 32 moves either to the left or to the right along the spindle 26 until it meets the thrust washer 38 with its end face 32a at the left-hand end of the spindle 26 and the rotation of the spindle is electronically switched off.

In this state, the end face 32a of the spindle nut 32 is thus in contact with the thrust washer 38 of the end stop and axial forces acting on the thrust tube 30, for example, caused by forces introduced by a user, can be absorbed by the damping element 36. Another overload event absorbed by the damping element 36 is when, for example, the spindle nut hits the end stop at too high a speed or with too high a force.

FIG. 3 shows an enlarged view of the end stop, in particular of the damping element 36, and FIG. 4 shows a longitudinal cross-section through the damping element 36 on the spindle 26.

It can be seen here that the damping element 36 preferably consists of a cylindrically curved stamped part 60, which has a plurality of cutouts 62 arranged offset from one another in the circumferential direction. Webs remain between the cutouts, which webs thus transmit forces occurring in the axial direction, which is to say, in the direction of the spindle axis 14, and the cutouts are elastically deformable.

As shown in particular by FIG. 5, the damping element 36 consists of a roughly rectangular stamped part 60 made of steel, out of which are stamped out several cutouts 62 which are arranged in rows one above the other and offset.

These cutouts 62 preferably have a stress-optimized bone-shaped or dumbbell-shaped design.

The flat stamped part 60 is rolled along its longitudinal ides to forma hollowcylindrical damping element 36 as shown in FIG. 6.

Preferably, the edges of the rolled stamped part 60 that are contiguous with one another are not firmly joined to each other, but rather there remains a gap 64. Alternatively, the edges that are contiguous with one another can be joined to each other by means of, for example, (laser) welding. The elongated cutouts 62 extend with their longer side in the circumferential direction of the damping element 36. A plurality of rows of cutouts 62 arranged one above the other along the longitudinal center axis 66 are provided, wherein the cutouts 62 of each row are arranged offset with respect to the cutouts 62 of the adjacent rows. Moreover, it is known that the stamped layers can be wound one on top of the other to further increase the spring forces that can be imaged in small installation spaces.

The damping element 36 has spring-elastic properties due to the plurality of cutouts 62 arranged offset from one another since the webs between the cutouts 62 can deform elastically when axial force is applied to the damping element 36. This is illustrated in FIG. 9a and FIG. 9b. The damping element 36 acts similarly to a plurality of disc springs arranged one above the other.

In contrast to the prior art, where a plastically deformable body was used as the damping element, it is now proposed according to the invention to use a spring-elastic damping element 36 such that, in the event of an overload event, the load forces that occur are elastically absorbed and the damping element returns substantially undamaged to its original shape after the overload event.

In a load event, the end stop or alternatively the damping element can absorb forces, for example, of 300-1500 newtons or more or alternatively energies in the order of 20-150 joules. The spring force of the damping element 36 can be individualized, for example, by means of the choice of material and the number of cutouts 62.

The elastic damping element 36 thus prevents that these extraordinary forces affect the gear and ultimately the drive motor and damage the same.

In the illustrated embodiment example, the spindle 26 may, for example, have a diameter of about 8 millimeters, whereas the damping element 36 has an inner diameter of, for example, about 8.1 millimeters and an axial length of, for example, about 10 to 30 millimeters. The thickness of the stamped spring steel sheet is preferably in the range of 0.3 to 1 millimeter, wherein a thickness of 0.5 millimeter is particularly preferred.

The spring action of the damping element 36 or alternatively the spring force is also given by the diameter of the damping element 36, the axial length of the damping element 36 and the size and shape as well as the number of cutouts 62 and wound layers.

In FIG. 8, the spring function of the damping element 36 is elucidated. When a force vector acts in arrow direction 68 on one of the end faces of the damping element 36, along the bending line a compression of the springy metal cross-sections arranged one above the other in the area of this bending line 70 occurs between the cutouts 62. In so doing, miniaturized bending springs 69 which are stacked one on top of the other are formed in the vertical direction along the bending lines 70.

FIG. 8 shows that a plurality of bending lines 70 arranged parallel to each other are formed, where, by way of example, only three bending lines 70 are shown.

FIG. 8, FIG. 9a and FIG. 9b show that each cutout 62 is preferably bone-shaped. According to FIG. 8 and FIG. 9, the bone shape results from the fact that cutouts 62 are respectively punched or cut out of the spring steel sheet and uniformly distributed in horizontal extension around the circumference, which cutouts are offset from one another in the vertical direction to form voids. Each cutout 62 is formed at the end by a semicircular arch 71 with a first larger diameter. The two semicircular arches 71 are respectively connected to each other on the edge side via a center area 72. The edge sides of the center area 72 are closer together than comparatively the diameter of the semicircular arches 71.

This results in the characteristic bone shape. FIG. 9a and FIG. 9b show the deformation of this bone-shaped structure when a force vector acts in the arrow direction 68, deforming the center area 72 into a center area 72′ with reduced spacing, forming the bending springs 69 shown by way of example in FIG. 8, stacked one above the other in the axial direction.

FIG. 10 shows a modified embodiment of a damping element 36a, in which the loosely fitting discs arranged at the ends mentioned previously in the first embodiment example are replaced by a curled rim 67 running around the circumference. Accordingly, the curled rim 67 replaces the loose discs at the ends, and this is advantageous in the sense of a savings in components used because no more discs are required. The curled rim also ensures reliable and symmetrical application of force to the spring structure of the slotted damping element 36a because the curled rim 67 is formed as a beveled part from the spring steel material of the damping element 36a, whereas a loose washer is able to cant or slip.

FIG. 10 shows that the two ends of the curled rim 67 meet in the region of the vertical gap 64, where they form a wedge-shaped notch 73.

In this example, the vertical gap 64 is shown open. However, the invention is not limited to this. Various embodiments have been shown in the general description, by which means the gap 64 can be closed or spanned. The means for spanning the gap 64 described in the general part of the description are applicable to all embodiments of the invention.

In this regard, FIG. 11 shows a third embodiment of a damping element 36 b consisting of a winding body 74. In the example shown, the winding body 74 consists of an inner winding 75 and an outer winding 76 covering the inner winding at an angle of 360°. It this matter, it is preferred if the vertical longitudinal side of the inner winding end 77 is approximately opposite the vertical longitudinal side of the outer winding end 78 at a radial distance. This also ensures symmetrical application of force to the damping element 36 b without the damping element deforming, bulging or even breaking when force is applied.

FIG. 12 shows one of the various options for spanning the vertical gap 64 with a tab structure formed from individual connection tabs 79. The connection tabs only span the gap 64 in bits. In this case, connection tabs 79 formed on one end of the stamped part and punched out of the spring steel material are present in the region of one end of the stamped part, which connection tabs are parallel to one another and have a mutual spacing.

The lobe-shaped connection tabs 79 engage with a positive fit n associated lobe-shaped connection cutouts 80 on the part lying opposite. Such a positive mechanical fit connection is also known in cardboard materials which may be connected to each other as pieces of a puzzle. Such a tab structure is an additional safeguard against uneven bulging or spreading of the spring sleeve in a radial direction when subjected to a compressive vertical force. It is understood that the tab structure is applicable to any of the above-described embodiment examples of a damping element 36, 36a,36b.

### REFERENCE LIST

10 Spindle drive device
12 Spindle housing
14 Spindle axis
16a End piece
16b End piece
18 Motor gear unit
20 Spindle unit
22a Bearing element
22b Bearing element
24 Guide tube
26 Spindle
28 Roller bearing
30 Thrust tube
32 Spindle nut
32a End face
33 Bearing assembly
34 Bearing element
36 Damping element
38 Thrust washer
40 Securing disk
42 Drive motor
44 Motor shaft
46 Gear
48 Gear shaft
50 Ring gear
52 Coupling
54 Housing tube
56 Compression spring
58 Guide sleeve
60 Stamped part
62 Cutout
64 Gap
66 Longitudinal center axis
67 Curled rim
68 Arrow direction (force vector)
69 Bending spring
70 Bending line
71 semicircular arch (of 62)
72 Center area, 72′ (of 62)
73 Notch (of 67)
74 Winding body
75 Inner winding
76 Outer winding
77 Inner winding end
78 Outer winding end
79 Connection tab
80 Connection cutout
81 Curved section (of 79)
82 Connection part (of 79)
83 Attachment (of 79)

1. A spindle assembly for a spindle drive device comprising:
a thrust tube;
a spindle nut, which is arranged on the thrust tube in a rotationally fixed manner, wherein the spindle nut can be brought into threaded engagement with a spindle of the spindle drive device, and
an end stop for the spindle nut is arranged on the spindle,
wherein the end stop comprises a damping element consisting of a stamped part which is hollow-cylindrical in shape and has spring-elastic properties.

2. The spindle assembly according to claim 1, wherein the damping element is loosely arranged on the spindle.

3. The spindle assembly of claim 1, wherein the stamped part comprises a plurality of elongated cutouts extending in the circumferential direction of the rolled stamped part, which cutouts are provided in a plurality of circumferentially extending rows offset from each other.

4. The spindle assembly according to claim 1, wherein the cutouts of the stamped part have a dumbbell-shaped or bone-shaped configuration.

5. The spindle assembly according to claim 1, wherein the end stop comprises a thrust washer which is movably arranged axially on the spindle and which forms a stop for the spindle nut.

6. The spindle assembly according to claim 1, wherein the damping element is arranged between the thrust washer and a bearing element arranged on the spindle, wherein the bearing element slides against the inner circumferential surface of the thrust tube.

7. The spindle assembly according to claim 1, wherein the end stop assembly comprises the thrust washer, the damping element and the bearing element is fixed on the spindle by a securing disk.

8. A spindle drive device with a spindle assembly according to claim 1.

9. The spindle drive device according to claim 8 for moving doors, tailgates or hoods of a motor vehicle.

10. The spindle assembly according to claim 1, wherein the damping element configured as an end stop is configured as a slotted spring steel sleeve.

11. The spindle assembly according claim 1, wherein the damping element has, at least on one end face, a curled rim beveled from the spring steel material.

12. The spindle assembly according to claim 1, wherein the damping element is configured as a winding body.

13. The spindle assembly according to claim 1, wherein the vertical gap between the opposing longitudinal sides of the damping element is partially open or open over the entire length.

14. The spindle assembly according to claim 1, wherein the vertical gap between the opposing longitudinal sides of the damping element is spanned at least in part by spot welds.

15. The spindle assembly according to claim 1, wherein the vertical gap between the opposing longitudinal sides of the damping element is spanned at least in pieces by connection tabs.
